(19) United States
(12) Patent Application Publication
(10) Pub. No.: US 2018/0210565 A1
(43) Pub. Date: Jul. 26, 2018

(54) MOUSE DEVICE WITH ADJUSTABLE SENSOR MODULE

(71) Applicants: DEXIN ELECTRONIC LTD., DONGGAUN GUANGDONG (CN); DEXIN CORPORATION, NEW TAIPEI CITY (TW)

(72) Inventor: YUAN-JUNG CHANG, NEW TAIPEI CITY (TW)

(21) Appl. No.: 15/417,141

(22) Filed: Jan. 26, 2017

(51) Int. Cl. G06F 3/0354; G06F 3/038

(52) U.S. Cl. CPC G06F 3/03544; G06F 3/0383

(57) ABSTRACT

A mouse device is provided in the present disclosure. The mouse device includes a housing and a sensor module. An accommodation space is located in the housing. The sensor module includes a plurality of sensors. The sensor module is received in the accommodation space. The arrangement of the sensors of the sensor module in the accommodation space is adjustable.

### BACKGROUND OF THE INVENTION

### 1. Field of the Invention

The instant disclosure relates to mouse device; in particular, to a mouse device with an adjustable sensor module.

### 2. Description of Related Art

A mouse device is a general input device of a computer system. Compared to the touchscreen technology, the mouse device has many advantages, such as high resolution and speed. For some jobs it is necessary to use the higher resolution of the mouse device, such as computer graphics or competitive gaming.

Even if the present mouse devices generally have high resolution, the sensitivity of the mouse device will be changed according to different gripping manners. For example, the sensitivity of gripping by the fingers is generally better than that of gripping by the palm.

### SUMMARY OF THE INVENTION

A mouse device is provided in the present disclosure. The mouse device includes a housing and a sensor module. An accommodation space is located in the housing. The sensor module includes a plurality of sensors. The sensor module is received in the accommodation space. The arrangement of the sensors of the sensor module in the accommodation space is adjustable.

A mouse device is provided in the present disclosure. The mouse device includes a housing and a sensor module. An accommodation space is located in the housing. A plurality of connection units is located in the accommodation space. A recess is located in the accommodation space. The sensor module includes a plurality of sensors. The sensors of the sensor module are mounted on the connection units. The sensors of the sensor module are electrically connected to the connection units. Each of the sensors of the sensor module includes at least one protrusion located at the bottom thereof. The protrusion of each sensor is detachably mounted in the recess such that the sensor is capable of moving along the recess.

In order to further the understanding regarding the instant disclosure, the following embodiments are provided along with illustrations to facilitate the disclosure of the instant disclosure.

### BRIEF DESCRIPTION OF THE DRAWINGS

FIG. 1 is a schematic diagram of a mouse device according to an embodiment of the present disclosure.

FIG. 2 is another schematic diagram of a mouse device according to an embodiment of the present disclosure.

FIG. 3 is another schematic diagram of a mouse device according to an embodiment of the present disclosure.

FIGS. 4A-4C are schematic diagrams of a matrix substrate in FIG. 1.

FIGS. 5A-5H are schematic diagrams of the matrix substrate and the sensor module in FIG. 1.

FIG. 6A is a schematic diagram of an accommodation space of the mouse device in FIG. 1.

FIG. 6B is another schematic diagram of an accommodation space of the mouse device in FIG. 1.

FIG. 7 is a schematic diagram of the sensor module received in the accommodation space of the mouse device in FIG. 1.

FIG. 8A is another schematic diagram of the mouse device according to the embodiment of the present disclosure.

FIG. 8B is a schematic diagram of the sensor of the mouse device moving in the accommodation space.

FIG. 8C is another schematic diagram of the sensor of the mouse device moving in the accommodation space.

FIG. 8D is a front view of the mouse device of the present disclosure.

FIG. 8E is a side view of the sensor of the present disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment for a Mouse Device]

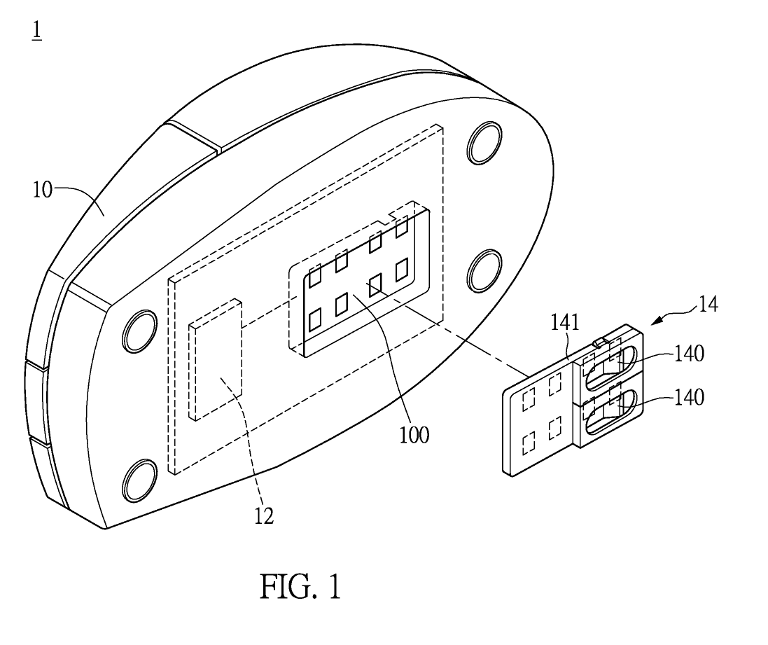

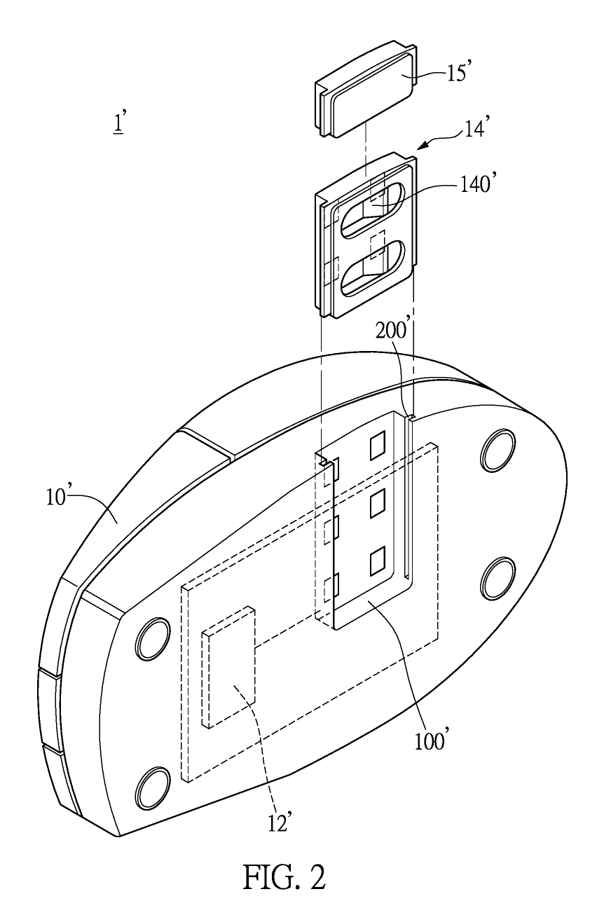

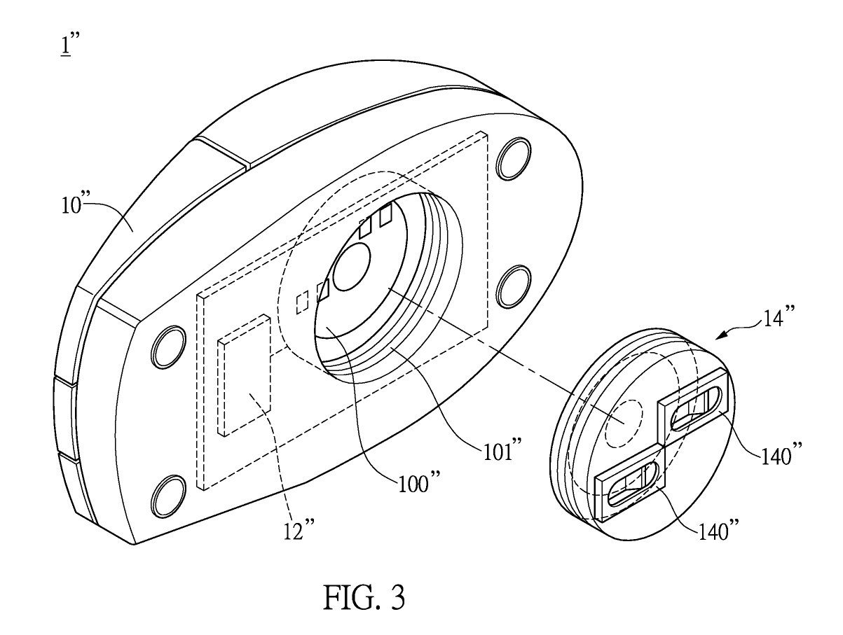

Referring to FIGS. 1-3, FIG. 1 is a schematic diagram of a mouse device according to an embodiment of the present disclosure. FIG. 2 is another schematic diagram of a mouse device according to an embodiment of the present disclosure. FIG. 3 is another schematic diagram of a mouse device according to an embodiment of the present disclosure.

A mouse device 1 includes a housing 10, a processing module 12 and a sensor module 14. In the embodiment, the sensor module 14 includes two sensors 140 and a substrate 141. The sensors 140 are mounted on the substrate 141. In another embodiment, the number of the sensors 140 of the sensor module 14 can be variable. The processing module is electrically connected to the sensor module 14 for receiving detecting signals of the sensor module 14. The sensor 140 includes an optical sensor or a laser sensor, such as an infrared sensor or a Blu-ray sensor.

An accommodation space 100 is located in the housing 10 for receiving the sensor module 14. In other words, the sensor module 14 is detachably mounted in the accommodation space 100. In another embodiment, the sensor module 14 can be movably mounted in the accommodation space 100. In FIG. 2, two slots 200′ are located in the sidewall of the housing 10′. The sensor module 14′ and a blanking unit 15′ are together mounted in the accommodation space 100′ through the slots 200′.

Referring to FIG. 3, in the embodiment, the sensor module 14″ includes two sensors 140″. The arrangement of the sensors 140″ is oblique. The housing 10″ in FIG. 3 has a female thread 101″. The sensor module 14″ is threadedly received in the accommodation space 100″ through the female thread 101′. As mentioned above, the sensor modules 14, 14′ 14″ can be adjustable and replaceable.

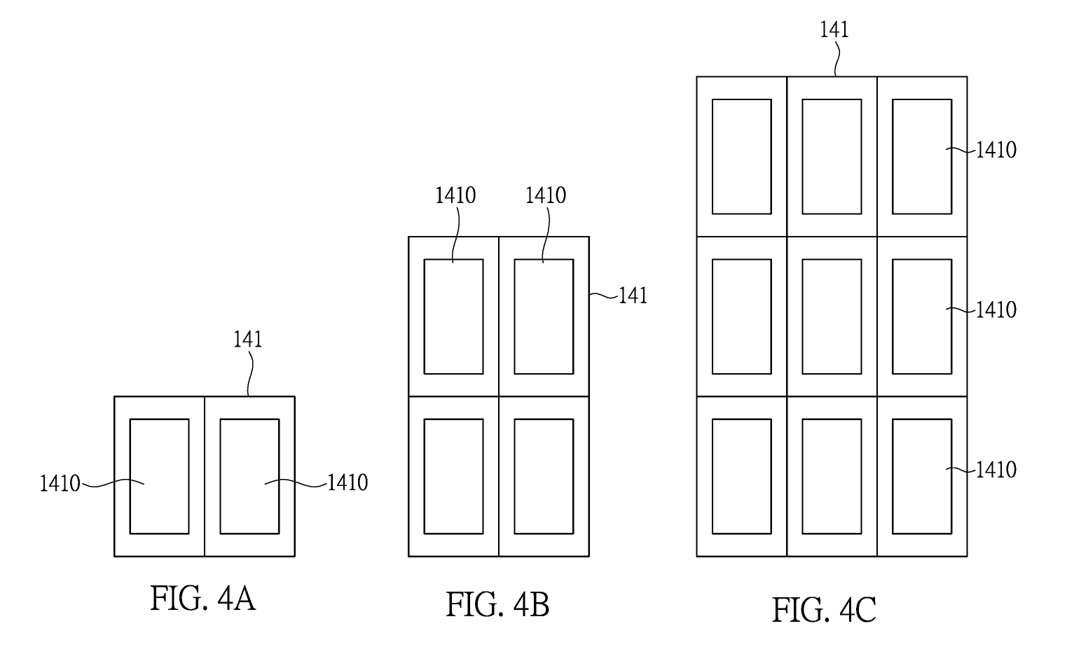

Referring to FIGS. 4A-4C, FIGS. 4A-4C are schematic diagrams of a matrix substrate in FIG. 1.

The sensor module 14 includes a matrix substrate 141 and a plurality of sensor areas 1410 located on the matrix substrate. The sensor area 1410 is used for mounting the sensor. The matrix substrate 141 includes M×N sensor areas, M≥1 and N≥1. As shown in FIGS. 4A-4C, the matrix substrate 141 can include 2×1 sensor areas, 2×2 sensor areas or 3×3 sensor areas.

In the embodiment, the sensors 140 of the sensor module 14 are mounted on the sensor areas 1410 of the matrix substrate 141. The processing module 12 is electrically connected to the sensors 140 of the sensor module 14 for receiving detecting signals of the sensors 140 and outputting a cursor control signal to a computer system (not shown). In the embodiment, the sensors 140 are detachably mounted on the sensor areas 1410 of the matrix substrate 141.

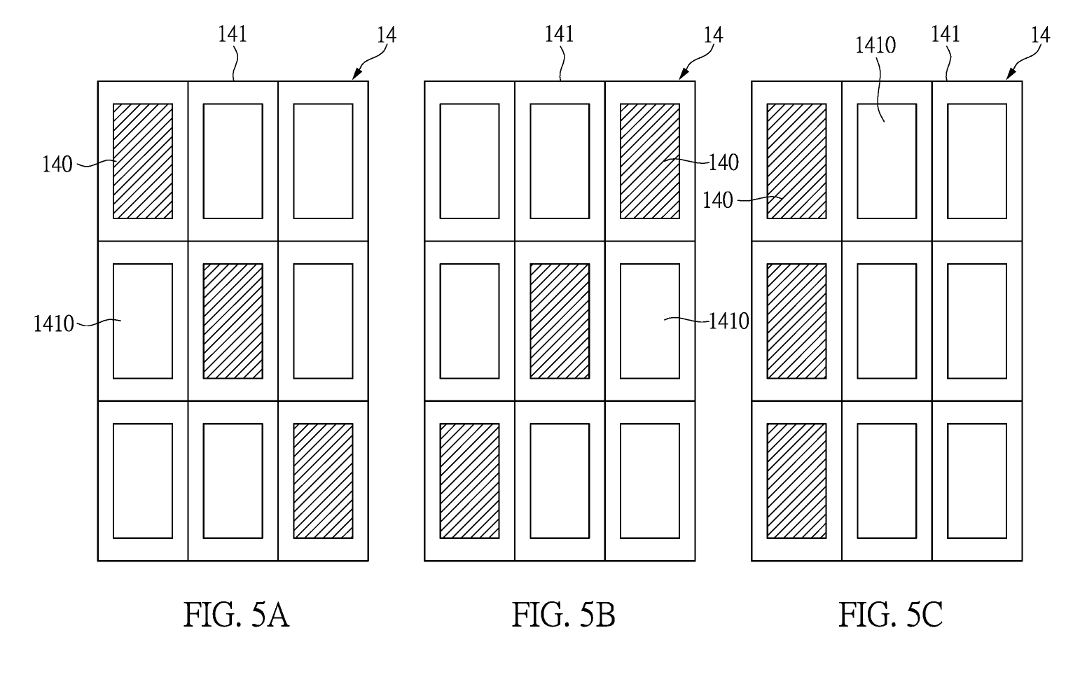

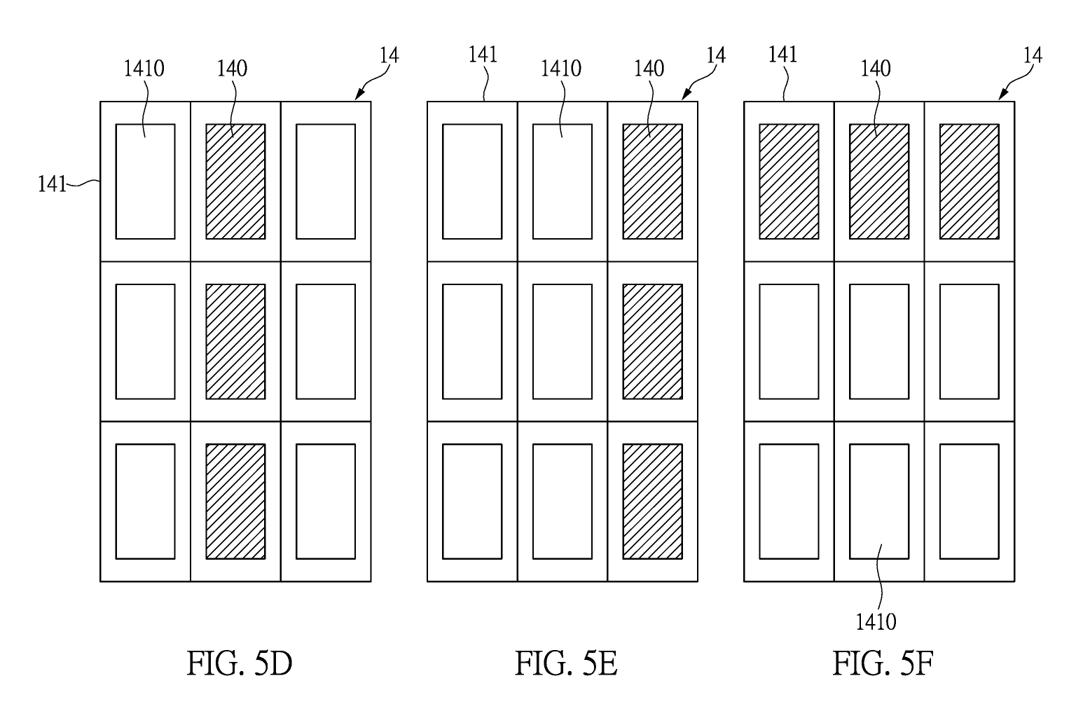

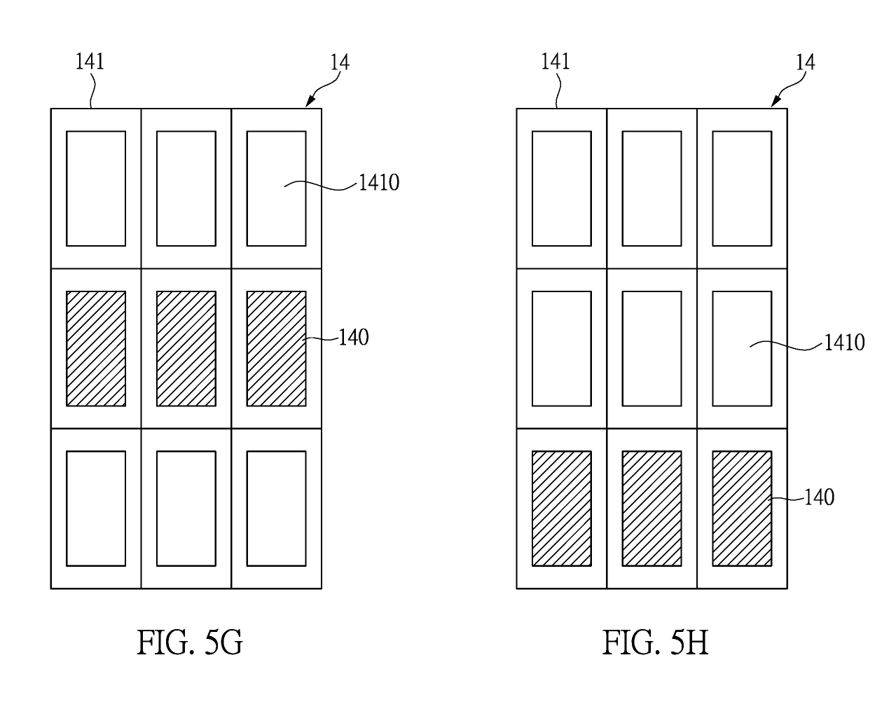

Referring to FIGS. 5A-5H, FIGS. 5A-5H are schematic diagrams of the matrix substrate and the sensor module in FIG. 1.

In the embodiment, the matrix substrate 141 includes 3×3 sensor areas and the sensor module includes 3 sensors 140. As shown in FIG. 5A and FIG. 5B, the three sensors 140 are arranged on the diagonal sensor areas 1410 of the matrix substrate 141.

In the embodiment, the arrangement of the sensors 141 of the sensor module 14 is determined according to user's gripping manner. For example, the arrangements of the sensors 141 of the sensor module 14 in FIGS. 5A-5B are adapted for a user obliquely gripping the mouse device.

In the embodiment, a long axis of the sensor 140 of the sensor module 14 is parallel to a long axis of the mouse device 1. In the other embodiment, the long axis of the sensor 140 can be not parallel to that of the mouse device 1. Therefore, the arrangement of the sensors 140 of the sensor module 14 can be more flexible.

In addition, the number and the arrangement of the sensors 140 of the sensor module 14 can be variable. The optimization process will be executed by specific software and firmware for the specific arrangement of the sensors 140

As shown in FIGS. 5C-5E, the sensors 140 can be mounted on the sensor areas 1410 of one column of the matrix substrate 141 as shown in FIGS. 5C-5E. The arrangement of the sensors 140 in FIG. 5C is adapted for a left-handed person. The arrangement of the sensors 140 in FIG. 5E is adapted for a right-handed person. The arrangement of the sensors 140 in FIG. 5D is used for enhancing the sensitivity of the mouse device 1.

As shown in FIGS. 5F-5H, the sensors 140 of the sensor module can be mounted on the sensor areas 1410 of one row of the matrix substrate 141. The arrangement of the sensors 140 in FIG. 5F is adapted for a person using their finger to grip and control the mouse device 1. The arrangement of the sensors 140 in FIG. 5H is adapted for a person using their palm to grip the mouse device 1. The arrangement of the sensors 140 in FIG. 5G is used for enhancing the sensitivity of the mouse device 1.

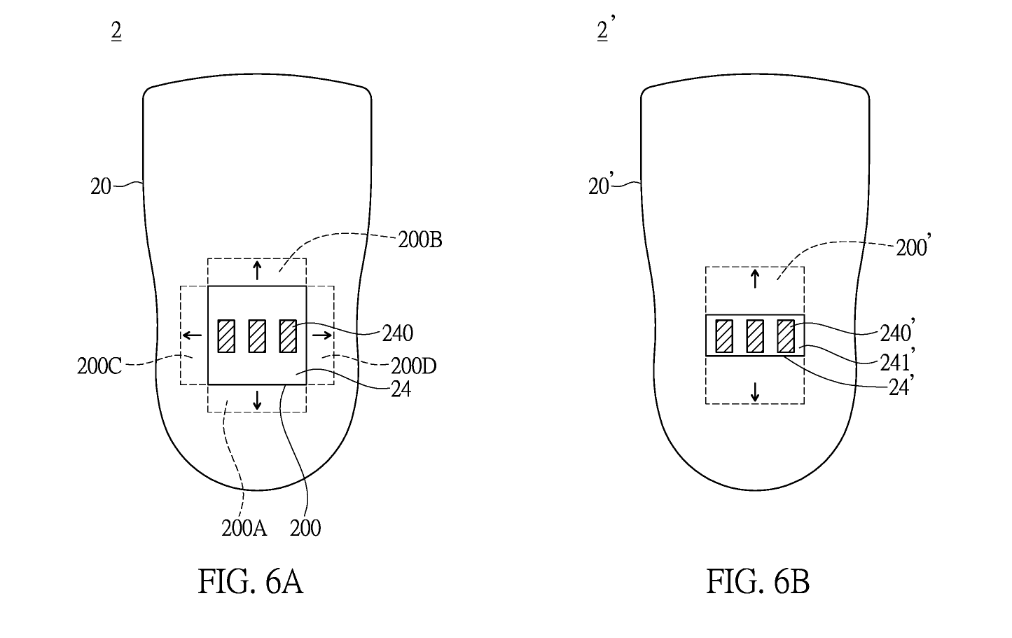

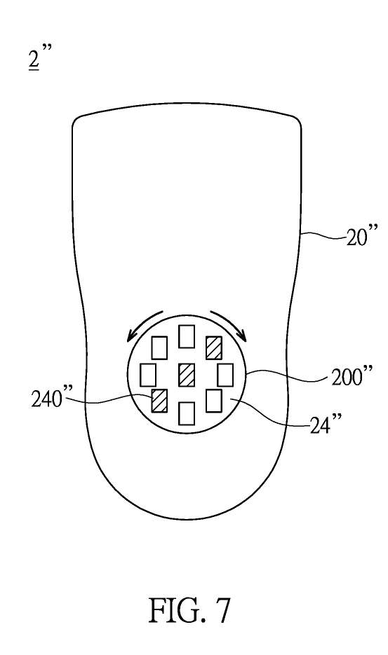

Referring to FIG. 6A, FIG. 6B and FIG. 7, FIG. 6A is a schematic diagram of an accommodation space of the mouse device in FIG. 1. FIG. 6B is another schematic diagram of an accommodation space of the mouse device in FIG. 1. FIG. 7 is a schematic diagram of the sensor module received in the accommodation space of the mouse device in FIG. 1.

Referring to FIG. 6A, an accommodation space 200 is located in the housing 20 of the mouse device 2 for receiving the sensor module 24. In the embodiment, a first space 200A, a second space 200B, a third space 200C and a forth space 200D are located in the housing 20, which are located beside the accommodation space 200. In some embodiments, the sensor module 24 can be mounted in the accommodation space 200 and first space 200A or in the the accommodation space 200 and second space 200B for adjusting the location of the sensors 240 of the sensor module 24.

Referring to FIG. 6B, the sensor module 24′ includes a matrix substrate 241′ and three sensors 240′. The area of the sensor module 24′ is smaller than that of the accommodation space 200′. Therefore, the sensor module 24′ is movably mounted in the accommodation space 200′.

Referring to FIG. 7, the sensor module 24 is circular. The sensor module 24″ is rotatably mounted in the accommodation space 200″ of the housing 20″. The three sensors 240″ are arranged along a diameter of the sensor module 24″.

[Another Embodiment for a Mouse Device]

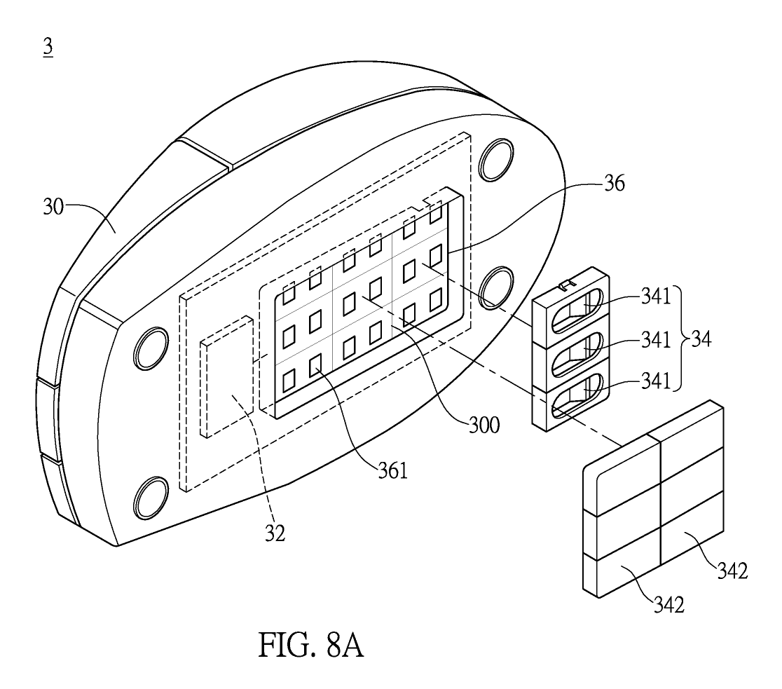

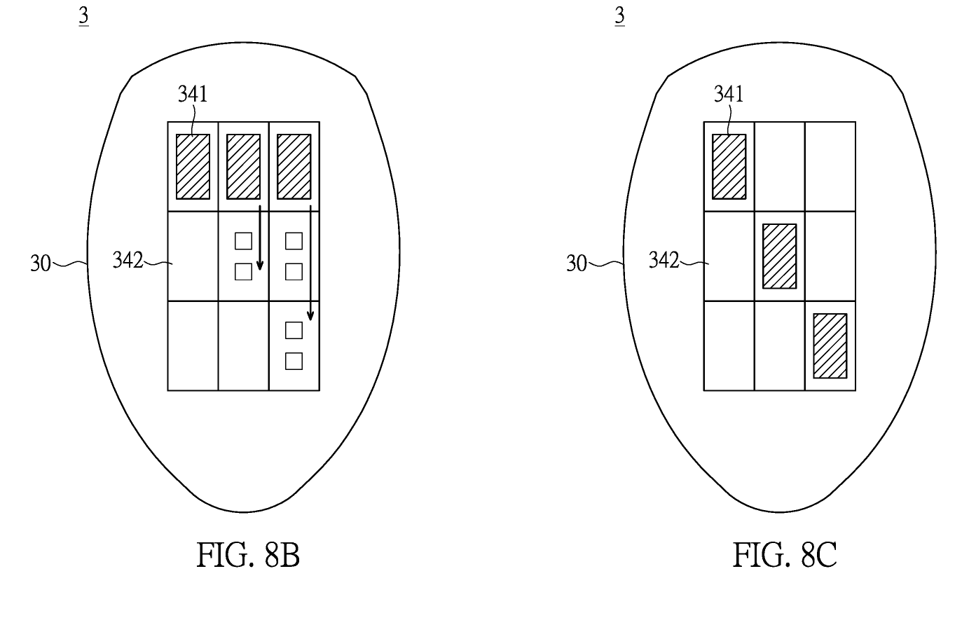

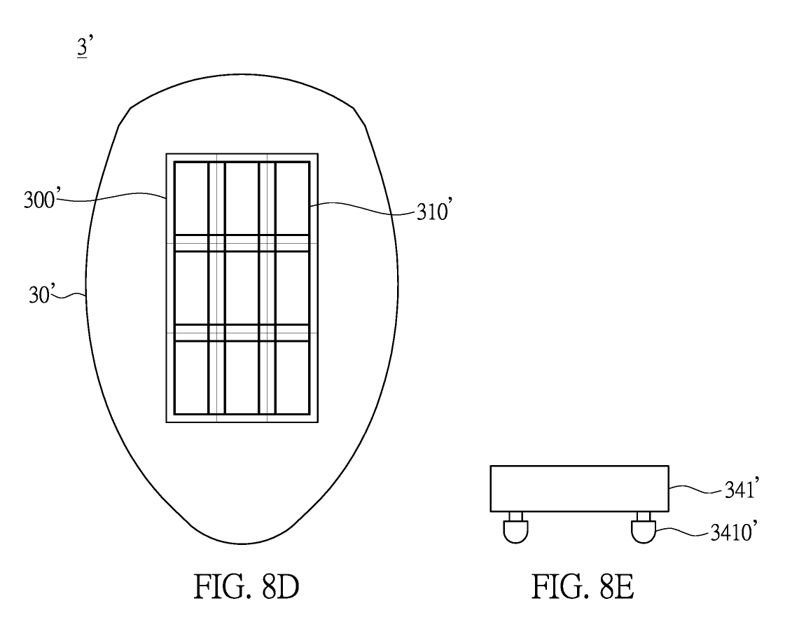

Referring to FIG. 8A, FIG. 8A is another schematic diagram of the mouse device according to the embodiment of the present disclosure.

A mouse device 3 includes a housing 30, a processing module 32, a sensor module 34 and a matrix connection module 36. An accommodation space 300 is located in the housing 30. The matrix connection module 36 is mounted in the accommodation space 300. The matrix connection module 36 includes a plurality of connection units 361. The sensor module 34 includes a plurality of sensors 341. The number of the sensors 341 is less than that of the connection units 361.

Each sensor 341 is mounted on one connection unit 361 of the matrix connection module 36. In the embodiment, the matrix connection module includes 3×3 connection units 361. The sensor module 34 includes 3 sensors 341. The sensors 341 of the sensor module 34 can be arranged as shown in FIGS. 5A-5H. In the embodiment, the connection unit 361 is a metal contact corresponding to a contact of the sensor 341 (not shown). When the sensors 341 of the sensor module 34 are mounted on the connection units 361 of the matrix connection module 36, the sensors 341 of the sensor module 34 are electrically connected to the corresponding connection units 361 and the processing module 32. The sensor module 34 further includes a plurality of blanking units 342. In the embodiment, the blanking units 342 and the sensors 341 are together mounted on the connection units 361 of the accommodation space 300. The sensors 341 and the blanking unit 342 are detachablely mounted in the accommodation space. In the embodiment, the size of the blanking unit 342 is equal to that of the sensors 341. The blanking unit 342 is used for covering other connection units 361.

Referring to FIG. 8B and FIG. 8C, FIG. 8B is a schematic diagram of the sensor of the mouse device moving in the accommodation space. FIG. 8C is another schematic diagram of the sensor of the mouse device moving in the accommodation space.

In the embodiment, a recess (not shown) is located in the accommodation space 300. Therefore, the sensor 341 and the blanking unit 342 can be movably mounted in the accommodation space 300 according to the recesses (not shown). When the user wants to change the arrangement of the sensors 341 of FIG. 8B to that of FIG. 8C, the central sensor 341 firstly should be detached from the accommodation space 300. Then the sensor 341 in first row and the second column can be downwardly moved to the central area. Finally, a blanking unit 342 is mounted in the area of the first row and the second column. Therefore, the sensors 341 of the sensor module 34 can be arranged as shown in FIG. 8C.

Referring to FIG. 8D and FIG. 8E, FIG. 8D is a front view of the mouse device of the present disclosure. FIG. 8E is a side view of the sensor of the present disclosure.

In the embodiment, a recess 310′ is located in an accommodation space 300′ of the mouse device 3′. The recess 310′ is lattice-like. As shown in FIG. 8E, the sensor 341′ has at least two protrusions 3410′. In the embodiment, the sensor 341′ has four protrusions 3410′. Similarly, each of the blanking units 342 has four protrusions 3410′. Each protrusion 3410′ is hemispherical and received in the recess 310′. Therefore, the sensors 341′ and the blanking unit 361′ can be movably mounted in the recess 310′ according to the protrusions 3410′ received in the recess 310′. The arrangement of the sensors 341′ and the blanking unit 361′ can be adjustable.

The mouse device of the present disclosure includes a plurality of detachable sensors and a plurality of blanking units. The sensors of the sensor module can be movably arranged according to the user's gripping manner. Therefore, the sensitivities of the mouse device to different user's gripping manners can be enhanced.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A mouse device comprising:
a housing, an accommodation space defined in the housing; and
a sensor module comprising a plurality of sensors, wherein the sensor module is received in the accommodation space;
wherein the arrangement of the sensors of the sensor module in the accommodation space is adjustable.

2. The mouse device of claim 1, further comprising:
a processing module, electrically connected to the sensor module, receiving signals of the sensors of the sensor module and outputting a cursor control signal to a computer system.

3. The mouse device of claim 1, wherein the sensor module is movably defined in the accommodation space.

4. The mouse device of claim 1, wherein the sensor module is detachably defined in the accommodation space.

5. The mouse device of claim 1, wherein the sensor module further comprising:
a matrix substrate comprising a plurality of sensor areas, the sensors of the sensor module are mounted on the sensor areas, wherein a number of the sensors of the sensor module is less than a number of the sensor areas of the matrix substrate.

6. The mouse of claim 1, wherein the matrix substrate comprises N×N sensor areas, the sensor module comprising N sensors, the N sensors are mounted on a column, a row or one of two diagonals of sensor areas of the matrix substrate.

7. The mouse device of claim 1, further comprising:
a matrix connection module, defined in the accommodation space, the matrix connection module comprising a plurality of connection units;
wherein the number of the sensors of the sensor module is less than the number of the connection units of the matrix connection module, the sensors of the sensor module are detachably mounted on the connection units of the matrix connection module, the connection units of the matrix connection module are electrically connected to the processing module, the sensors of the sensor module are electrically connected to the connection units of the matrix connection module.

8. The mouse device of claim 7, wherein the matrix connection module comprises N×N connection units, the sensor module includes N sensors, the N sensors are mounted on one of the columns of the connection units of the matrix connection module, one of the rows of the connection units of the matrix connection module or one of two diagonals of the connection units of the matrix connection module.

9. The mouse device of claim 7, wherein a recess is defined in the accommodation space, the sensors of the sensor module are movably defined in the recess, the sensors move along the recess for adjusting the arrangement of the sensors of the sensor module.

10. A mouse device comprising:
a housing, an accommodation space defined in the housing, wherein a plurality of connection units is defined in the accommodation space, a recess is defined in the accommodation space, and
a sensor module comprising a plurality of sensors, the sensors of the sensor module mounted on the connection units, the sensors of the sensor module electrically connected to the connection units;
wherein each of the sensors of the sensor module comprises at least one protrusion defined at the bottom of each of the sensors, the at least one protrusion of the sensor is detachably received in the recess such that the sensor is capable of moving along the recess.

11. The mouse device of claim 10, wherein the sensors of the sensor module are detachably mounted in the recess of the accommodation space.

12. The mouse device of claim 10, wherein a number of the sensors of the sensor module is less than a number of the connection units of the matrix connection module.
